(19) United States
(12) Patent Application Publication
(10) Pub. No.: US 2007/0270003 A1
(43) Pub. Date: Nov. 22, 2007

(54) POWER SUPPLY APPARATUS HAVING MULTIPLE POWER OUTPUT DEVICES

(75) Inventors: Wen-Hsiang Lin, Taoyuan Hsien (TW); Szu-Lu Huang, Taoyuan Hsien (TW); Hung-Chang Hsieh, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 11/534,104

(22) Filed: Sep. 21, 2006

(30) Foreign Application Priority Data
May 19, 2006 (TW) 095117971

(51) Int. Cl. H01R 13/648

(52) U.S. Cl. 439/101

(57) ABSTRACT

A power supply apparatus includes a main body, a power input device, a first power output device and a second power output device. The power input device is coupled to an input terminal of the main body. The first power output device includes a first cable and a first connector. The first cable is interconnected between a first output terminal of the main body and a first surface of the first connector. An extension part is extended from the first surface of the first connector. The second power output device includes a second cable and a second connector. A first surface of the second connector is suppressed by the extension part of the first connector to facilitate securely fixing the first connector and the second connector in a power socket, so that a regulated output voltage is outputted from the first and second output devices to the power socket.

### FIELD OF THE INVENTION

The present invention relates to a power supply apparatus, and more particularly to a power supply apparatus having multiple power output devices.

### BACKGROUND OF THE INVENTION

Power supply apparatuses are essential for many electronic appliances such as personal computers, industrial computers, servers, communication products or network products. Usually, the user may simply plug a power input connector of the power supply apparatus into an AC wall outlet commonly found in most homes or offices so as to receive an AC voltage. The power supply apparatus will convert the AC voltage into a regulated DC output voltage for powering the electronic appliance and/or charging a battery built-in the electronic appliance.

Referring to FIG. 1, a schematic perspective view of a conventional power supply apparatus having multiple power output devices is illustrated. The power supply apparatus 1 includes a main body 10, a power input device 11, a first power output device 12 and a second power output device 13. The power input device 11 is connected to the input terminal of the main body 10 for receiving an AC voltage from an external power source. The first power output device 12 and the second power output device 13 are connected to the output terminals of the main body 10. The AC voltage transmitted from the external power source is converted by the circuitry of a printed circuit board inside the main body 10 into different regulated DC output voltages. The different regulated DC output voltages are outputted from the power output devices 12 and 13 for powering different electronic devices (not shown). The first power output device 12 includes a first cable 121 and a first connector 122. The second power output device 13 includes a second cable 131 and a second connector 132. The first connector 122 is connected to an end of the first cable 121. The second connector 132 is connected to an end of the second cable 131.

For example, when the power supply apparatus 1 is applied to a personal computer system, the first connector 122 of the first power output device 12 and the second connector 132 of the second power output device 13 should be plugged into corresponding sockets (not shown) on the motherboard of the computer system. For complying with the specifications of corresponding sockets on the motherboard, the first connector 122 of the first power output device 12 is a 20- or 24-pin connector to be coupled with the 20- or 24-hole socket (i.e. the first power socket). The second connector 132 of the second power output device 13 is a 4- or 8-pin connector to be coupled with the 4- or 8-hole socket (i.e. the second power socket). As known, the pin numbers of the first connector 122 and the second connector 132 should be equal to those of the first power socket and the second power socket, respectively. For example, the 20-pin first connector 122 fails to be applied to the 24-hole first power socket, and the 4-pin second connector fails to be applied to the 8-hole second power socket. For complying with the power sockets with different number of holes, at least two power supply apparatuses should be purchased, which is costly and wastes resources.

For solving the above problems, a power supply apparatus having a composite connector is disclosed in for example US Patent Application No. 2005/0202726, and the contents of which are hereby incorporated by reference. By using a single power supply apparatus, the connectors can be selectively combined or separated according to the number of holes of the power socket on the motherboard. As a consequence, such a power supply apparatus is advantageous for flexibility to be applied in different instances. Referring to FIG. 2(a), the power supply apparatus 3 as disclosed in US Patent Application No. 2005/0202726 includes a main body 30 and a first connector 31. The first connector 31 is coupled to the main body 30 through a first cable 32. The first connector 31 includes a plurality of pins 33 such as twenty pins 33. The first connector 31 includes a first engaging element 34 such as a protrusion track at a left side thereof.

The power supply apparatus 3 further comprises a second connector 35. The second connector 35 is coupled to the main body 30 through a second cable 36. The second connector 35 includes a plurality of pins 38 such as four pins 38. The second connector 35 further includes a second engaging element 37 such as a gliding channel at a right side thereof and corresponding to the first engaging element 34 of the first connector 31. Once the first engaging element 34 is coupled with the second engaging element 37, the first connector 31 and the second connector 35 are combined as a composite connector having a total number of twenty-four pins, as can be seen in FIG. 2(b).

Please refer to FIG. 2(a) again. The power supply apparatus 3 further comprises a third connector 40. The third connector 40 is coupled to the main body 30 through a third cable 41. The third connector 40 includes a plurality of pins 42 such as four pins 42. The third connector 40 further includes a third engaging element 43 such as a protrusion track at a left side thereof. The power supply apparatus 3 further comprises a fourth connector 44. The fourth connector 44 is coupled to the main body 30 through a fourth cable 45. The fourth connector 44 includes a plurality of pins 47 such as four pins 44. The fourth connector 44 further includes a fourth engaging element 46 such as a gliding channel at a right side thereof and corresponding to the third engaging element 43 of the third connector 40. Once the third engaging element 43 is coupled with the fourth engaging element 46, the third connector 40 and the fourth connector 44 are combined as another composite connector having a total number of eight pins, as can be also seen in FIG. 2(b).

Please refer to FIGS. 3(a) and 3(b), which are partial exploded views illustrating the power supply apparatus 3 to be used in a motherboard having two power sockets. The motherboard 50 has a first power socket 51 and a second power socket 53 mounted thereon. In a case that the first power socket 51 has twenty holes 52 and the second power socket 53 has four holes 54, the twenty pins 33 of the first connector 31 and the four pins 38 of the second connector 35 can be plugged into corresponding holes 52 and 54 of the sockets 51 and 53, respectively.

Please refer to FIG. 4, which is a partial exploded view illustrating the power supply apparatus 3 to be used in another motherboard having two different power sockets. The motherboard 50 of FIG. 4 has a first power socket 55 and a second power socket 57 mounted thereon. In a case that the first power socket 55 has twenty-four holes 56, the first connector 31 and the second connector 35 may be combined as a composite connector having a total number of twenty-four pins by coupling the first engaging element 34 with the second engaging element 37. As a consequence, the twenty-four pins of the composite connector can be plugged into the holes 56 of the first power socket 55. In another case that the second power socket 57 has eight holes 58, the third connector 40 and the fourth connector 44 may be combined as another composite connector having a total number of eight pins by coupling the third engaging element 43 with the fourth engaging element 46. As a consequence, the eight pins of this composite connector can be plugged into the holes 58 of the second power socket 57.

The power supply apparatus having a composite connector as described above, however, still has some drawbacks. For example, the structure of respective connector is complicated. In addition, it is not easy to plug the composite connector into the single power socket.

### SUMMARY OF THE INVENTION

It is an object of the present invention to provide a power supply apparatus having multiple power output devices, in which at two connectors of the present power supply apparatus are selectively combined or separately plugged into the power socket, thereby increasing flexibility to be applied in different instances. In addition, the structure of the individual connector is very simple, and thus the power supply apparatus of the present invention is cost-effective and user-friendly.

In accordance with an aspect of the present invention, there is provided a power supply apparatus having multiple power output devices. The power supply apparatus includes a main body, a power input device, a first power output device and a second power output device. The power input device is coupled to an input terminal of the main body. The first power output device includes a first cable and a first connector. The first cable is interconnected between a first output terminal of the main body and a first surface of the first connector. An extension part is extended from the first surface of the first connector. The second power output device includes a second cable and a second connector. The second cable is interconnected between a second output terminal of the main body and a first surface of the second connector. The first surface of the second connector is suppressed by the extension part of the first connector to facilitate securely fixing the first connector and the second connector in a power socket, so that a regulated output voltage is outputted from the first and second output devices to the power socket.

In an embodiment, the first connector has a plurality of pins, and the second connector has a plurality of pins.

In an embodiment, the first connector has twenty pins, and the second connector has four pins.

In an embodiment, the first connector has four pins, and the second connector has twenty pins.

In an embodiment, the pins of the first connector are extended from a second surface opposite to the first surface of the first connector.

In an embodiment, the extension part is extended from the first surface of the first connector at a first side of the first connector, where the first side is adjacent to and substantially perpendicular to the first surface and the second surface of the first connector.

In an embodiment, the extension part is extended from an edge of the first surface of the first connector.

In an embodiment, the pins of the second connector are extended from a second surface opposite to the first surface of the second connector.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view of a conventional power supply apparatus;

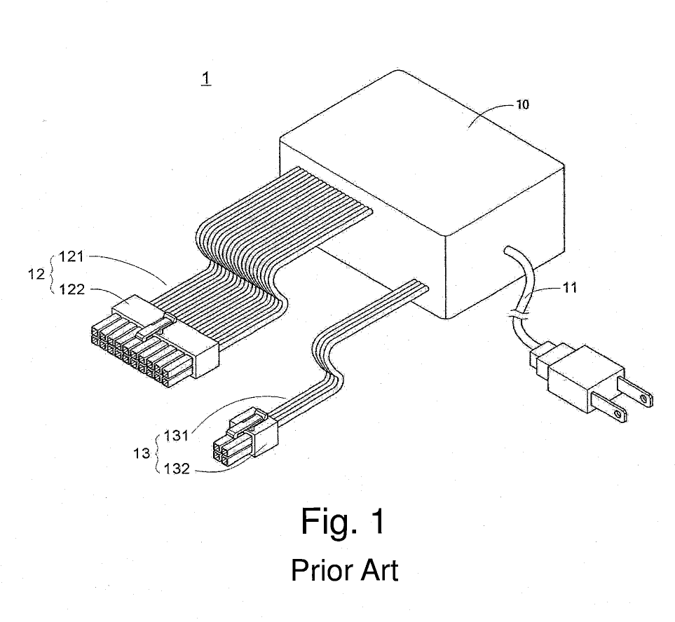

FIG. 2(a) is a schematic perspective view of another conventional power supply apparatus having a composite connector;

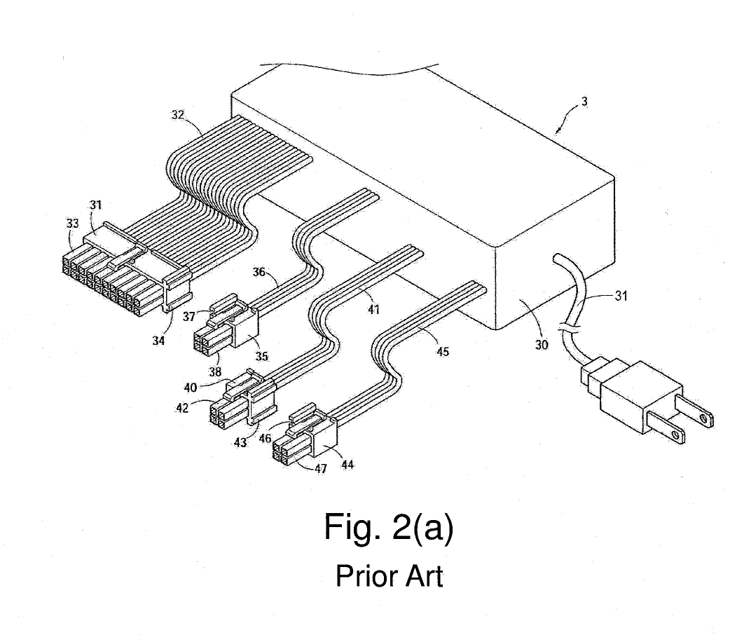

FIG. 2(b) is a schematic perspective view of the power supply apparatus of FIG. 2(a), in which two connectors are combined as the composite connector;

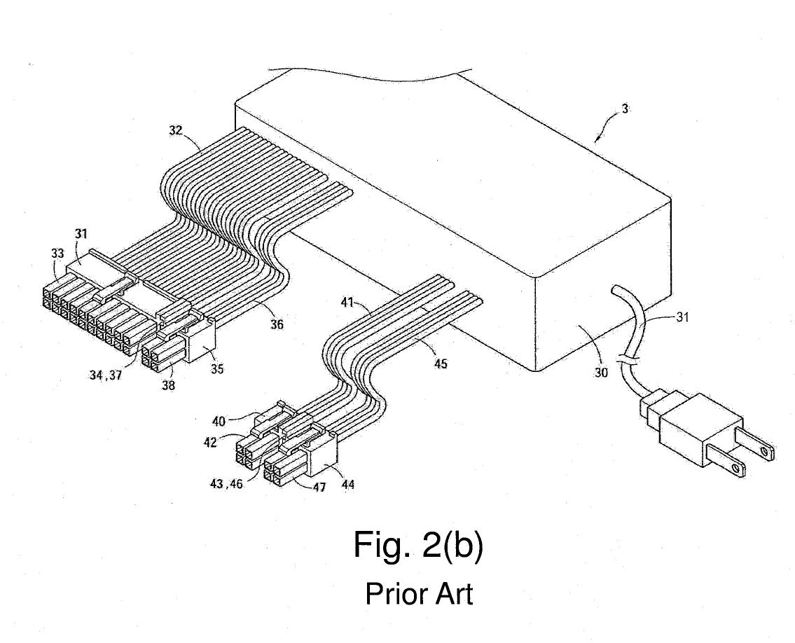

FIGS. 3(a) and 3(b) are partial exploded views illustrating the power supply apparatus of FIG. 2(a) to be used in a motherboard having two power sockets;

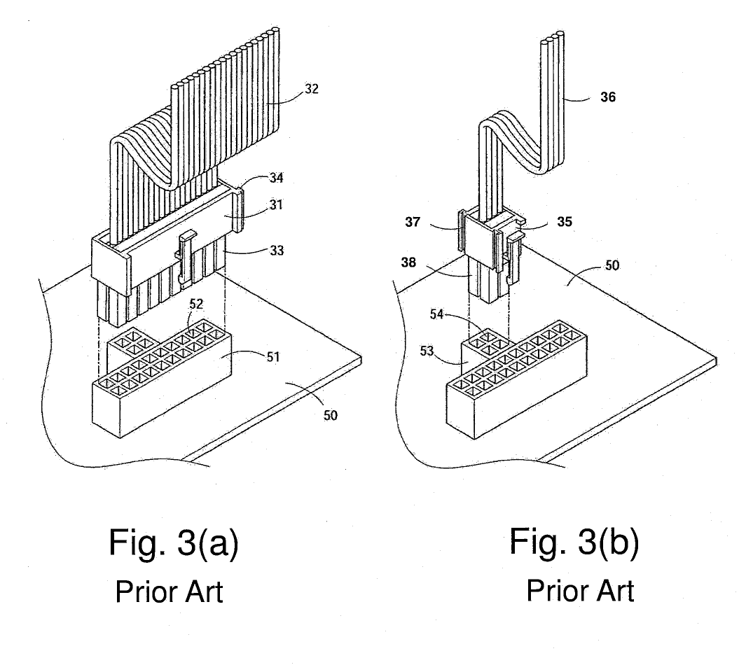

FIG. 4 is a partial exploded view illustrating the power supply apparatus of FIG. 2(a) to be used in another motherboard having two different power sockets;

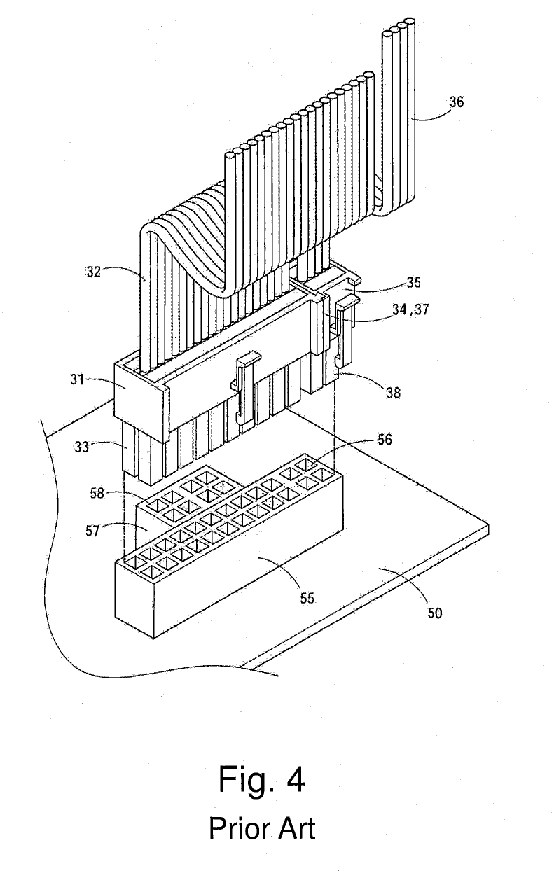

FIG. 5 is a schematic perspective view of a power supply apparatus having multiple power output devices according to a preferred embodiment of the present invention;

FIGS. 6(a) and 6(b) are partial exploded views illustrating the power supply apparatus of FIG. 5 to be used in a motherboard having two power sockets; and

FIG. 7 is a partial assembled view illustrating the power supply apparatus of FIG. 5 to be used in another motherboard.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

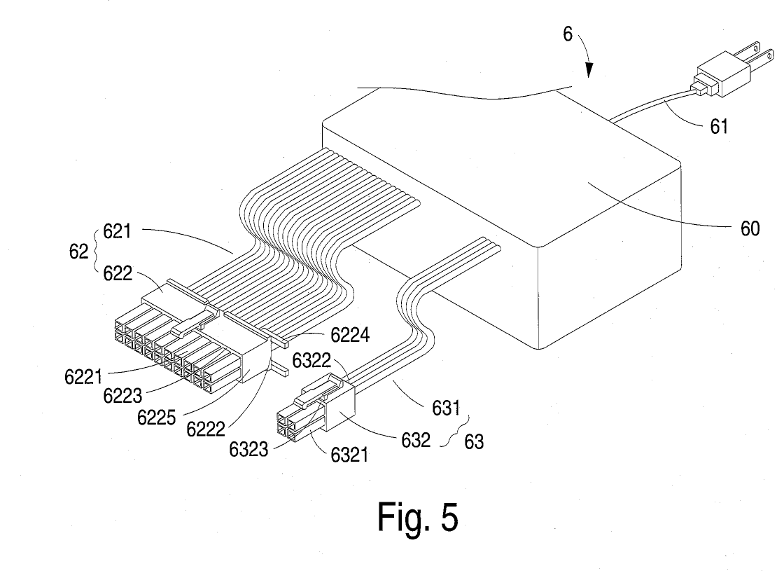

Referring to FIG. 5, a schematic perspective view of a power supply apparatus having multiple power output devices according to a preferred embodiment of the present invention is illustrated. In this embodiment, the power supply apparatus 6 includes a main body 60, a power input device 61, a first power output device 62 and a second power output device 63. The power input device 61 is connected to the input terminal of the main body 60 for receiving an AC voltage from an external power source. The first power output device 62 and the second power output device 63 are connected to the output terminals of the main body 60. The AC voltage transmitted from the external power source is converted by the circuitry of a printed circuit board (not shown) inside the main body 60 into different regulated DC output voltages. The different regulated DC output voltages are outputted from the power output devices 62 and 63 for powering different electronic devices (not shown). The first power output device 62 includes a first cable 621 and a first connector 622. The second power output device 63 includes a second cable 631 and a second connector 632. The first cable 621 is coupled to a first surface 6222 of the first connector 622. The second cable 632 is coupled to a first surface 6322 of the second connector 632.

Please refer to FIG. 5 again. The first connector 622 further includes a plurality of pins 6221 such as twenty pins extended from a second surface 6223 of the first connector 622. The second surface 6223 and the first surface 6222 are opposite surfaces of the first connector 622. The first connector 622 further includes at least an extension part 6224 extended from the first surface 6222 at the first side 6225 of the first connector 622. In an embodiment, the first side 6225 is adjacent to and substantially perpendicular to the first surface 6222 and the second surface 6223. It is preferred that the extension part 6224 extended from an edge of the first surface 6222. The second connector 632 further includes a plurality of pins 6321 such as four pins extended from a second surface 6323 of the second connector 632. The second surface 6323 and the first surface 6322 are opposite surfaces of the second connector 632.

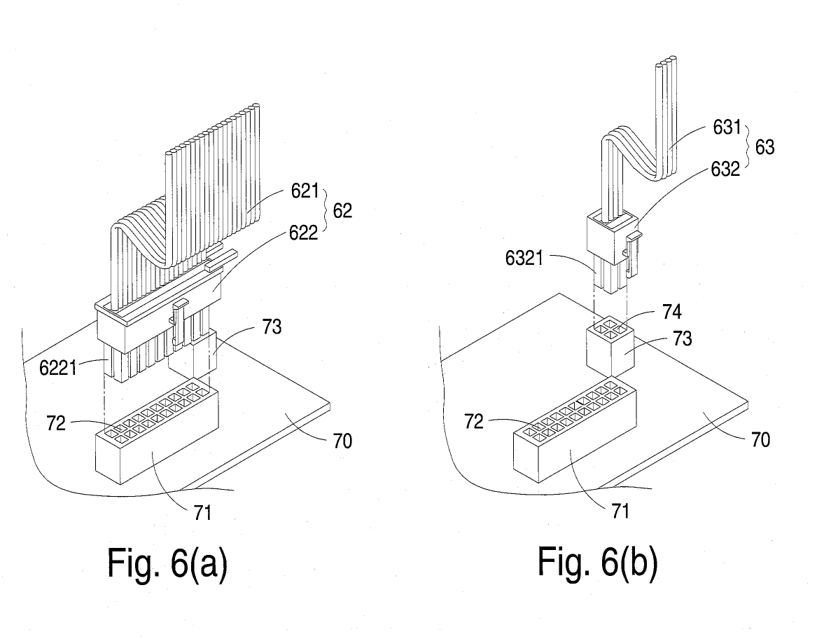

Please refer to FIGS. 6(a) and 6(b), which are partial exploded views illustrating the power supply apparatus 6 to be used in a motherboard having two power sockets. The motherboard 70 has a first power socket 71 and a second power socket 73 mounted thereon. In a case that the first power socket 71 has twenty socket holes 72 and the second power socket 73 has four socket holes 74, the twenty pins 6221 of the first connector 622 and the four pins 6321 of the second connector 632 can be plugged into corresponding socket holes 72 and 74 of the sockets 71 and 73, respectively.

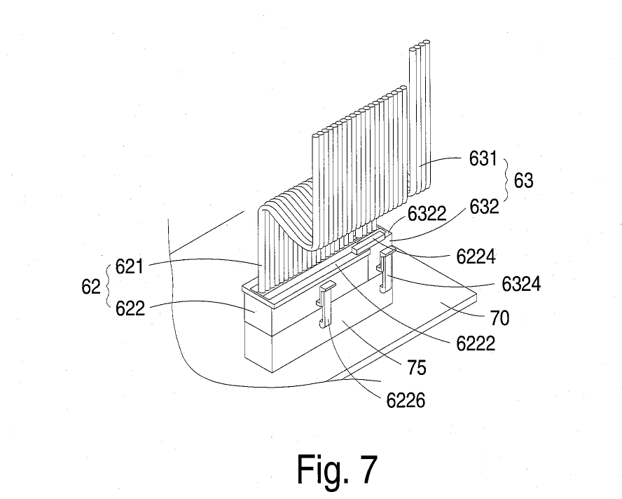

Please refer to FIG. 7, which is a partial exploded view illustrating the power supply apparatus 6 to be used in another motherboard having two different power sockets. The motherboard 70 of FIG. 7 has a first power socket 75 and a second power socket (not shown) mounted thereon. In a case that the first power socket 75 has twenty-four socket holes, a total of twenty-four pins of the first connector 622 and the second connector 632 can be securely fixed into corresponding socket holes of the first power socket 75.

Hereinafter, a process of plugging the first power output device 62 and the second power output device 63 into the first power socket 75 will be illustrated as follows. First of all, the four pins 6321 of the second connector 632 of the second power output device 63 are inserted into corresponding socket holes of the first power socket 75. Then, the twenty pins 6221 of the first connector 622 of the first power output device 62 are inserted into corresponding socket holes of the first power socket 75. Meanwhile, the first surface 6322 of the second connector 632 is suppressed by the extension part 6224, which is extended from the first surface 6222 of the first connector 622. As a result, the first connector 622 and the second connector 632 are securely fixed in the first power socket 75.

In the above embodiments, the first connector 622 and the second connector 632 can be selectively combined or separated according to the number of socket holes of the power socket on the motherboard by using a single power supply apparatus. That is, the power supply apparatus of the present invention may comply with different specifications of power sockets on the motherboard. Moreover, the socket holes of the first power socket 75 have specified foolproof mechanisms (not shown) to prevent erroneous insertion of the pins of the first connector 622 and the second connector 632. Alternatively, the first connector 622 and the second connector 632 may include resilient hooking elements 6226 and 6324, respectively, in order to facilitate fixing the first connector 622 and the second connector 632 in the first power socket 75.

Moreover, the power supply apparatus 6 may further include a third power output device and a fourth power output device. The operation principles of the third and fourth power output devices are similar to those of the first and second power output devices, and are not redundantly described herein. It is noted that, however, those skilled in the art will readily observe that numerous modifications and alterations of the extension part may be made while retaining the teachings of the invention. For example, the extension part can be disposed on the first surface of the second connector rather than the first connector. Likewise, after the first connector is plugged into the first power socket, the first surface of the first connector is suppressed by the extension part of the second connector, so that the first connector and the second connector are securely fixed in the power socket.

From the above description, two connectors of the present power supply apparatus are selectively combined or separately plugged into the power socket, thereby increasing flexibility thereof. By simply suppressing an extension part of one connector onto a surface of the other connector, these two connectors are securely fixed in the power socket. Since the structure of the individual connector is very simple, the power supply apparatus of the present invention is cost-effective and user-friendly.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply apparatus having multiple power output devices, said power supply apparatus comprising:
a main body;
a power input device coupled to an input terminal of said main body;
a first power output device including a first cable and a first connector, said first cable being interconnected between a first output terminal of said main body and a first surface of said first connector, wherein an extension part is extended from said first surface of said first connector; and
a second power output device including a second cable and a second connector, said second cable being interconnected between a second output terminal of said main body and a first surface of said second connector,
wherein said first surface of said second connector is suppressed by said extension part of said first connector to facilitate securely fixing said first connector and said second connector in a power socket, so that a regulated output voltage is outputted from said first and second output devices to said power socket.

2. The power supply apparatus according to claim 1 wherein said first connector has a plurality of pins, and said second connector has a plurality of pins.

3. The power supply apparatus according to claim 2 wherein said first connector has twenty pins, and said second connector has four pins.

4. The power supply apparatus according to claim 2 wherein said first connector has four pins, and said second connector has twenty pins.

5. The power supply apparatus according to claim 2 wherein said plurality of pins of said first connector are extended from a second surface opposite to said first surface of said first connector.

6. The power supply apparatus according to claim 5 wherein said extension part is extended from said first surface of said first connector at a first side of said first connector, where said first side is adjacent to and substantially perpendicular to said first surface and said second surface of said first connector.

7. The power supply apparatus according to claim 6 wherein said extension part is extended from an edge of said first surface of said first connector.

8. The power supply apparatus according to claim 2 wherein said plurality of pins of said second connector are extended from a second surface opposite to said first surface of said second connector.
